(19) United States
(12) Patent Application Publication
(10) Pub. No.: US 2021/0216808 A1
(43) Pub. Date: Jul. 15, 2021

(54) INFORMATION PROCESSING APPARATUS, INFORMATION PROCESSING SYSTEM, PROGRAM, AND INFORMATION PROCESSING METHOD

(71) Applicant: SONY CORPORATION, TOKYO (JP)

(72) Inventors: SAYAKA WATANABE, TOKYO (JP); JUN YOKONO, TOKYO (JP); NATSUKO OZAKI, TOKYO (JP); JIANING WU, TOKYO (JP); TATSUHITO SATO, TOKYO (JP)

(21) Appl. No.: 17/058,935

(22) PCT Filed: Apr. 12, 2019
(86) PCT No.: PCT/JP2019/015969

§ 371 Date: Nov. 25, 2020

(30) Foreign Application Priority Data
Jun. 5, 2018 (JP) 2018-107824

(51) Int. Cl. G06K 9/62; G06T 7/246; G06T 7/11; G10L 25/51; G10L 15/22; B25J 11/00; B25J 9/00

(52) U.S. Cl. CPC G06K 9/6202; G06T 7/248; G06T 7/11; B25J 9/0003; G10L 15/22; B25J 11/0005; G10L 25/51

(57) ABSTRACT

[Object] To provide an information processing apparatus, an information processing system, and an information processing method that are capable of performing natural interaction between a user and a robot. [Solving Means] An information processing apparatus includes: a state-change detection unit. The state-change detection unit compares reference image information regarding an autonomously acting robot acquired at a certain time point with comparison image information regarding the autonomously acting robot acquired at another time point, and detects a state change of the autonomously acting robot on the basis of a comparison result.

### TECHNICAL FIELD

The present technology relates to an information processing apparatus, an information processing system, a program, and an information processing method according to an autonomously acting robot.

### BACKGROUND ART

Recently, development of robots supporting life as partners for humans has been promoted. Examples of such robots include a pet-type robot simulating the body mechanism of four-legged walking animals such as dogs and cats or the movement thereof (e.g., Patent Literature 1).

Patent Literature 1 describes that an exterior unit formed of synthetic fibers in a form similar to that of the epidermis of authentic animal is attached to a pet-type robot to individualize their actions and behaviors. The exterior unit and the pet-type robot are electrically connected to each other, and the presence or absence of attachment of the exterior unit is judged by the presence or absence of the electrical connection.

### CITATION LIST

### Patent Literature

Patent Literature 1: Japanese Patent Application Laid-open No. 2001-191275

### DISCLOSURE OF INVENTION

### Technical Problem

An autonomously acting robot is desired to act so as to be capable of performing natural interaction between a user and the robot.

In view of the circumstances as described above, it is an object of the present technology to provide an information processing apparatus, an information processing system, a program, and an information processing method that are capable of performing natural interaction between a user and a robot.

### Solution to Problem

In order to achieve the above-mentioned object, an information processing apparatus according to an embodiment of the present technology includes: a state-change detection unit.

The state-change detection unit compares reference image information regarding an autonomously acting robot acquired at a certain time point with comparison image information regarding the autonomously acting robot acquired at another time point, and detects a state change of the autonomously acting robot on the basis of a comparison result.

By detecting the state change in this way, since the autonomously acting robot can be caused to take an action according to the detected state change, it is possible to perform natural interaction with a user.

The state change may be the presence or absence of an accessory attached to the autonomously acting robot.

The information processing apparatus may further include an action-control-signal generation unit that generates, for state-change-detection processing by the state-change detection unit, an action control signal of the autonomously acting robot so that a posture of the autonomously acting robot is the same as that in the reference image.

The comparison image information may be image information of the autonomously acting robot moved in accordance with the reference image information.

With such a configuration, the position and posture of the autonomously acting robot displayed on the comparison image can be similar to the position and posture of the autonomously acting robot displayed on the reference image.

The state-change detection unit may detect the state change from a difference between the comparison image information and the reference image information.

The reference image information may include a feature amount of a reference image, the comparison image information may include a feature amount of a comparison image, and the state-change detection unit may compare the feature amount of the comparison image with the feature amount of the reference image to detect the state change.

The reference image information may include segmentation information of pixels that belong to the autonomously acting robot, and the state-change detection unit may detect the state change by using the segmentation information to remove a region that belongs to the autonomously acting robot from the comparison image information.

The autonomously acting robot may include a plurality of parts, and the segmentation information may include pixel segmentation information for each of the plurality of parts distinguishable from each other.

The information processing apparatus may further include a self-detection unit that detects whether or not a robot detected to be of the same type as the autonomously acting robot is the autonomously acting robot.

With such a configuration, it is possible to detect, when a robot of the same type as the autonomously acting robot is detected, whether the detected robot of the same type is a mirror image in which the autonomously acting robot is displayed on a mirror or another robot different from the autonomously acting robot.

The self-detection unit may detect, on the basis of movement performed by the autonomously acting robot and movement performed by the robot detected to be of the same type, whether or not the robot detected to be of the same type is the autonomously acting robot displayed on a member that displays an object using specular reflection of light.

The self-detection unit may estimate a part point of the robot detected to be of the same type, and detect, on the basis of a positional change of the part point and movement of the autonomously acting robot, whether or not the robot detected to be of the same type is the autonomously acting robot displayed on a member that displays an object using specular reflection of light.

The autonomously acting robot may include a voice acquisition unit that collects a voice, and the state-change detection unit may compare a reference voice acquired by the voice acquisition unit at a certain time point with a comparison voice acquired by the voice acquisition unit at another time point and detect the state change of the autonomously acting robot on the basis of a comparison result.

As described above, in addition to the image information, the voice information may be used to detect the state change.

The autonomously acting robot may include an actuator that controls movement of the autonomously acting robot, and the state-change detection unit may compare a reference operation sound of the actuator at a certain time point with a comparison operation sound of the actuator acquired at another time point and detect the state change of the autonomously acting robot on the basis of a comparison result.

As a result, it is assumed that an accessory may have been attached to the region where the actuator is located, the state-change detection region can be narrowed down, and the state change detection can be performed efficiently.

The information processing apparatus may further include a trigger monitoring unit that monitors occurrence or non-occurrence of a trigger for determining whether or not the autonomously acting robot is to be detected by the state-change detection unit.

The trigger monitoring unit may compare image information regarding a shadow of the autonomously acting robot at a certain time point with image information regarding a shadow of the autonomously acting robot at another time point to monitor the occurrence or non-occurrence of the trigger.

The trigger monitoring unit may monitor the occurrence or non-occurrence of the trigger on the basis of an utterance of a user.

The trigger monitoring unit may monitor the occurrence or non-occurrence of the trigger on the basis of a predetermined elapsed time.

In order to achieve the above-mentioned object, an information processing system according to an embodiment of the present technology includes: an autonomously acting robot; and an information processing apparatus.

The information processing apparatus includes a state-change detection unit that compares reference image information regarding the autonomously acting robot acquired at a certain time point with comparison image information regarding the autonomously acting robot acquired at another time point, and detects a state change of the autonomously acting robot on the basis of a comparison result.

In order to achieve the above-mentioned object, a program according to an embodiment of the present technology causes an information processing apparatus to execute processing including the step of: comparing reference image information regarding an autonomously acting robot acquired at a certain time point with comparison image information regarding the autonomously acting robot acquired at another time point, and detecting a state change of the autonomously acting robot on the basis of a comparison result.

In order to achieve the above-mentioned object, an information processing method according to an embodiment of the present technology includes: comparing reference image information regarding an autonomously acting robot acquired at a certain time point with comparison image information regarding the autonomously acting robot acquired at another time point, and detecting a state change of the autonomously acting robot on the basis of a comparison result.

### Advantageous Effects of Invention

As described above, in accordance with the present technology, it is possible to perform more natural interaction between a user and a robot. Note that the effect described here is not necessarily limitative, and any of the effects described in the present disclosure may be provided.

### BRIEF DESCRIPTION OF DRAWINGS

FIG. 1 is a block diagram showing a configuration of an autonomously acting robot according to a first embodiment of the present technology.

FIG. 2 is a flowchart of a series of processes according to state-change-detection processing by accessory attachment of the autonomously acting robot according to the first embodiment.

FIG. 3 is a flowchart describing an example of state-change-detection processing in the first embodiment.

FIG. 4 is a diagram for describing an example of reference image information used for the state-change-detection processing.

FIG. 5 is a diagram showing an example of performing the state-change-detection processing using the reference image information.

FIG. 6 a block diagram showing a configuration of an autonomously acting robot according to a second embodiment.

FIG. 7 is a flowchart of a series of processes according to state-change-detection processing by accessory attachment of the autonomously acting robot according to the second embodiment.

FIG. 8 is a diagram describing self-detection processing in the second embodiment.

FIG. 9 is a diagram for describing state-change-detection processing in the second embodiment.

FIG. 10 is a flowchart of state-change-detection processing using segmentation in a third embodiment.

FIG. 11 is a diagram for describing the state-change-detection processing in the third embodiment.

FIG. 12 is a flowchart of state-change-detection processing using part detection in a fourth embodiment.

FIG. 13 is a diagram for describing state-change-detection processing in the fourth embodiment.

FIG. 14 is a flowchart of state-change-detection processing using a feature amount of an image in a fifth embodiment.

FIG. 15 is a flowchart of an example of state-change-detection processing in the case of not utilizing the difference with a robot information database in a sixth embodiment.

FIG. 16 is a flowchart of an example of state-change-detection processing in the case of not utilizing the difference with a robot information database in a seventh embodiment.

FIG. 17 is a diagram showing an information processing system according to an eighth embodiment.

FIG. 18 is a diagram showing an information processing system according to a ninth embodiment.

FIG. 19 is a diagram showing an information processing system according to tenth embodiment.

FIG. 20 is a diagram for describing state-change-detection processing.

FIG. 21 is a diagram for describing another example of the self-detection processing in the second embodiment.

FIG. 22 is a diagram describing another example of the self-detection processing.

### MODE(S) FOR CARRYING OUT THE INVENTION

An autonomously acting robot according to each embodiment of the present technology will be described below with reference to the drawings. Examples of the autonomously acting robot include a pet-type robot and a humanoid robot that support life as partners for humans and emphasize communications with humans. Here, a four-legged walking dog-type pet-type robot is exemplified as an autonomously acting robot, but the present technology is not limited thereto.

The pet-type robot according to each of the embodiments described below is configured to detect a state change due to, for example, whether or not an accessory is attached, e.g., an accessory such as clothing, hats, collars, ribbons, and bracelets were attached or the attached accessory was removed. Note that the state change that an accessory that had been attached was changed includes a state change that the attached accessory was removed and a state change that another accessory was newly attached.

By detecting the state change in this way, since the pet-type robot is capable of performing, on the basis of the state change detection result, an action corresponding to the detection result on a user, it is possible to make interaction between the user and the robot more natural.

This will be described below in detail.

### First Embodiment

(Configuration of Pet-Type Robot)

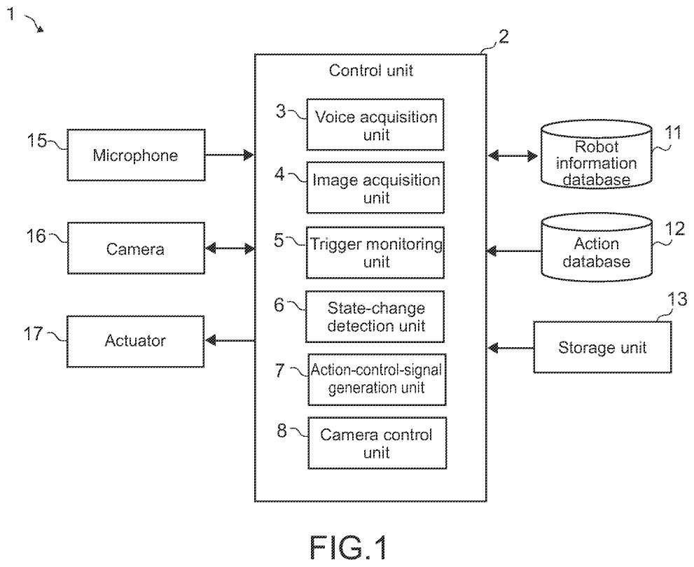

FIG. 1 shows a block diagram showing a configuration of a pet-type robot 1 according to this embodiment.

The pet-type robot 1 as information processing apparatus includes a control unit 2, a microphone 15, a camera 16, an actuator 17, a robot information database (DB) 11, an action database (DB) 12, and a storage unit 13.

The pet-type robot 1 includes a head portion unit, a body portion unit, leg portion units (four legs), and a tail portion unit. The actuator 17 is placed in the respective joints of the leg portion units (four legs), the connections between the respective leg portion units and the body portion unit, the connection between the head portion unit and the body portion unit, and the connection between the tail portion unit and the body portion unit, and the like. The actuator 17 controls the movement of the pet-type robot 1.

In addition, various sensors such as the camera 16, a human sensor (not shown), the microphone 15, and a GPS (Global Positioning System) (not shown) are mounted on the pet-type robot 1 in order to acquire data relating to surrounding environmental information,

The camera 16 is mounted on, for example, the head potion of the pet-type robot 1. The camera 16 images the surroundings of the pet-type robot 1 and the body of the pet-type robot 1 within a possible range. The microphone 15 collects the voice surrounding the pet-type robot 1.

The control unit 2 performs control relating to state-change-detection processing. The control unit 2 includes a voice acquisition unit 3, an image acquisition unit 4, a trigger monitoring unit 5, a state-change detection unit 6, an action-control-signal generation unit 7, and a camera control unit 8.

The voice acquisition unit 3 acquires information (voice information) relating to the voice collected by the microphone 15. The image acquisition unit 4 acquires information (image information) relating to an image captured by the camera 16.

The trigger monitoring unit 5 monitors occurrence or non-occurrence of a trigger for triggering the pet-type robot 1 to initiate the state change detection. Examples of the trigger include an utterance from a user, a certain predetermined elapsed time, and image information of the shadow of the pet-type robot 1. Here, an example in which the trigger monitoring unit 5 monitors occurrence or non-occurrence of the trigger on the basis of the utterance from the user will be described.

When the trigger monitoring unit 5 recognizes, on the basis of the voice information acquired by the voice acquisition unit 3, that a user has uttered a keyword that triggers starting of the state change detection, it determines that a trigger has occurred. When it is determined that a trigger has occurred, the state-change detection unit 6 executes state-change-detection processing. When it is determined that no trigger has occurred, the state-change-detection processing is not executed.

The keyword for determining the occurrence or non-occurrence of the trigger is registered in a database (not shown) in advance. The trigger monitoring unit 5 monitors the occurrence or non-occurrence of the trigger with reference to the registered keyword.

Examples of the keyword include, but are not limited to, compliments such as “cute”, “nice”, “good-looking”, and “cool” and accessory names such as “hat”, “cloth”, and “bracelet”. These keywords are set in advance, and keywords may be added through learning and updated from time to time.

By providing such the trigger monitoring unit 5, it is possible to quickly start the state-change-detection processing, and the pet-type robot 1 is capable of quickly reacting to actions such as attaching, detaching, and replacing an accessory of the pet-type robot 1 by a user, making it possible to perform more natural interaction.

The state-change detection unit 6 executes state-change-detection processing using image information acquired by the image acquisition unit 4. Specifically, the state-change detection unit 6 detects the state change of the pet-type robot 1, e.g., an accessory was attached to the pet-type robot 1 or the accessory attached to pet-type robot was removed.

The state-change detection unit 6 compares reference image information regarding the pet-type robot 1 imaged at a certain time point with comparison image information regarding the pet-type robot 1 imaged at another time point, and detects the state change of the pet-type robot on the basis of the comparison result. The reference image information has been registered in the robot information database (robot information DB) 11. Details of the state-change-detection processing as the information processing method will be described below.

The action-control-signal generation unit 7 generates, for the state-change-detection processing, an action control signal of the pet-type robot 1 so that the pet-type robot 1 is in the same position and posture as those in the reference image.

Further, the action-control-signal generation unit 7 selects, on the basis of the state change detection result of the detection by the state-change detection unit 6, an action model from the action database 12 to generate an action control signal of the pet-type robot 1.

For example, the action-control-signal generation unit 7 generates, on the basis of the state change detection result that a hat was attached to the pet-type robot 1, an action control signal for making an utterance or performing an action of shaking the tail in order for the pet-type robot 1 to express pleasure.

An internal state such as emotions of the pet-type robot 1 and physiological conditions including a battery level and a heated condition of the robot may be reflected in the voice and action generated on the basis of such a state change detection result.

For example, in the case where the state change is attachment of an accessory of a lion mane, an angry emotion may be reflected and an action such as barking frequently may be performed.

In addition, when the remaining battery level is small, an action such as not moving too much may be performed so that the power consumption is reduced.

When the pet-type robot is filled with heat and heated due to movement for a long time or the like, an action such as not moving too much may be performed for cooling.

The camera control unit 8 controls, during the state-change-detection processing, the camera 16 so that the optical parameters of the camera 16 are the same as the optical parameters at the time of acquiring reference image information.

The storage unit 13 includes a memory device such as a RAM and a nonvolatile recording medium such as a hard disk drive, and stores a program for causing the pet-type robot 1 as the information processing apparatus to execute the state-change-detection processing of the pet-type robot 1.

The program stored in the storage unit 13 is for causing the pet-type robot 1 as the information processing apparatus to execute processing including the step of comparing the reference image information regarding the pet-type robot 1 acquired at a certain time point with the comparison image information regarding the pet-type robot 1 acquired at another time point and detecting the state change of the pet-type robot 1 on the basis of the comparison result.

In the action database (action DB) 12, action models that define what actions the pet-type robot 1 should take at what conditions, and various action content defining files such as motion files for each action that define which actuator 17 should be driven at which timing and to what extent in order for the pet-type robot 1 to execute the action and a sound file in which voice data of the voice to be pronounced by the pet-type robot 1 at this time is stored are registered.

Information relating to the pet-type robot 1 is registered in the robot information database 11. Specifically, as information relating to the pet-type robot 1, control parameter information of the actuator 17 when the pet-type robot 1 has taken a certain posture, information of a reference image (reference image information) obtained by directly imaging a part of the body of the pet-type robot 1 that has taken the certain posture by the camera 16 mounted thereon, and sensor information such as optical parameter information of the camera 16 when capturing the reference image are registered in association with each other for each different posture.

The reference image information is information used during the state-change-detection processing.

Examples of the reference image information acquired at the certain time point include information that has been registered in advance at the time of shipping the pet-type robot 1 and information acquired and registered after the pet-type robot 1 is started to be used. Here, a case where the reference image information is information when no accessory is attached to a pet-type robot 21, which has been registered at the time of shipment, will be described as an example.

Examples of the image information include an image, a mask image of the robot region generated on the basis of this image, an RGB image of the robot region, a depth image of the robot region, an image from which only the robot region is cut out, a 3D shape of the robot region, their feature amount information, and segmentation information of pixels that belong to the robot region.

Hereinafter, as the specific posture of the pet-type robot 1, a posture when the right front leg is raised will be described as an example.

In the robot information database 11, image information regarding an image acquired by imaging the right front leg when the pet-type robot 1 raises the right front leg by the camera 16 mounted thereon is registered as reference image information that has been registered at the time of shipment. This image information is information when no accessory is attached to the pet-type robot 1.

Further, in the robot information database 11, posture information of the pet-type robot 1 at the time of imaging by the camera 16, specifically, control parameter information of the actuators 17 located at the joint of the right front leg, the connection between the head portion unit and the body portion unit, and the like, optical parameter information of the camera 16 at the time of imaging, the posture of raising the right front leg, and reference image information thereof are registered in association with each other.

By controlling, when the state change is detected, the posture of the pet-type robot 1 on the basis of the registered control parameter information of the actuator 17, the pet-type robot 1 is in the same position and posture as those of the pet-type robot 1 displayed in the reference image. By imaging the pet-type robot 1 in this posture on the basis of the registered optical parameter of the camera 16, image information of a comparison image (comparison image information) can be acquired. Then, by comparing this comparison image information with the registered reference image information, the state change of the pet-type robot 1 can be detected.

FIG. 4(A) shows an example of a mask image 80 of the robot region of the reference image of the pet-type robot 1 on which no accessory is attached at the time of shipping, and FIG. 4(B) shows an example of an RGB image 81 that is a morphological image of the robot region. Each of the figures is generated on the basis of an image obtained by imaging a right front leg 51 of the pet-type robot 1 using the camera 16 mounted thereon.

As shown in FIG. 4—As shown in FIG. 4(A), in the mask image 80 for reference, regions other than the robot region (here, the region of the right front leg 51 of the robot) are painted black, for example, and the robot region is a transparent template-image.

As shown in FIG. 4B, the RGB image 81 for reference is a template real image including the brightness distribution information and RGB information of the robot region.

(Outline of Processing Method Relating to State Change Detection)

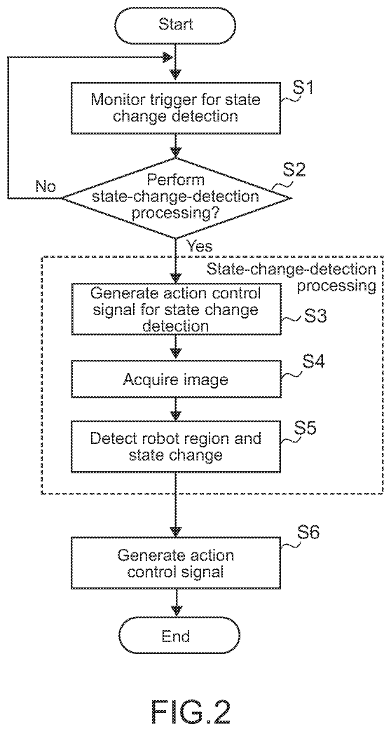

Next, a processing method relating to state change detection will be described with reference to FIG. 2. FIG. 2 is an example of a flowchart of a series of processes relating to state change detection.

As shown in FIG. 2, the trigger monitoring unit 5 monitors a trigger for state change detection (S1), and determines whether to perform the state-change-detection processing (S2).

When it is determined in S2 that the state-change-detection processing is not to be performed (No), the processing returns to S1.

When it is determined in S2 that the state-change-detection processing is to be performed (Yes), the processing proceeds to S3.

In S3, an action control signal is generated for state change detection by the action-control-signal generation unit 7 to cause the pet-type robot 1 to take a specific posture. By driving the actuator 17 on the basis of the control parameter information of the actuator 17 associated with a specific posture registered in the robot information database 11, it is possible to cause the pet-type robot 1 to take a specific posture.

Next, a part of the body of the pet-type robot 1 that has taken an action on the basis of the action control signal generated in S3 is imaged by the camera 16 controlled on the basis of optical parameter information associated with a specific posture registered in the robot information database 11. The captured image is acquired as comparison image information by the image acquisition unit 4 (S4).

Next, the state-change detection unit 6 compares reference image information associated with a specific posture registered in the robot information database 11 with comparison image information, and extracts a robot region to detect the region of a state change (S5). A specific method of detecting the state change in S 3 to S5 will be described below.

Next, the action-control-signal generation unit 7 generates an action control signal of the pet-type robot 1 (S6) on the basis of the detection result of the state-change detection unit 6. For example, the action-control-signal generation unit 7 generates, on the basis of the detection result that attachment of an accessory has been detected, an action control signal for causing the pet-type robot 1 to perform an action such as pronouncing a sound and shaking a tail to express joy for a user.

(Detail of State Change Detection Method)

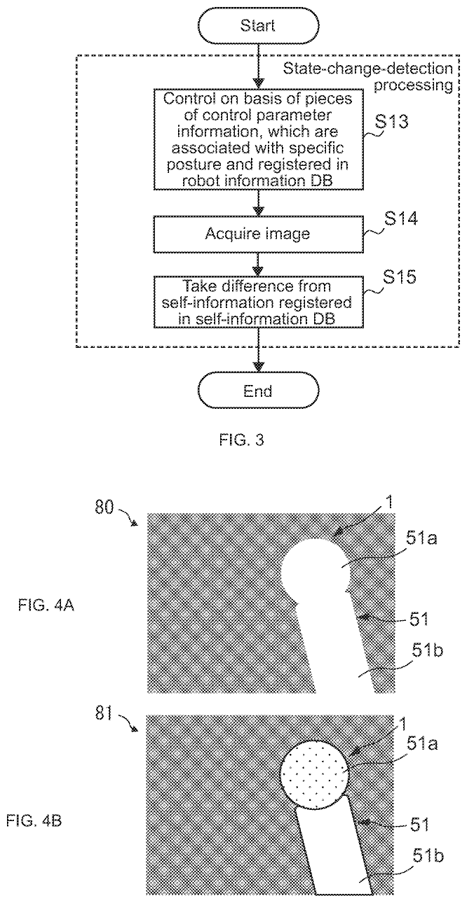

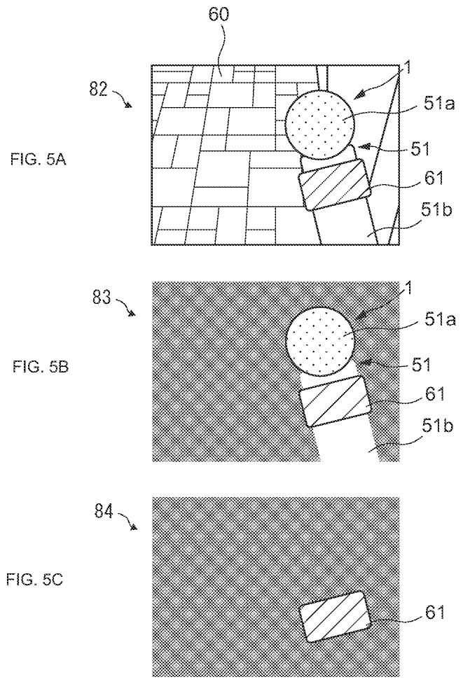

Next, a specific example of the state-change-detection processing of S3 to S5 in FIG. 2 will be described with reference to FIG. 3 to FIG. 5. FIG. 3 is a flowchart showing an example of the state-change-detection processing. FIG. 5 is a diagram showing an example of performing the state-change-detection processing using the reference image information. Steps S13 to S15 in FIG. 3 correspond to S3 to S5 in FIG. 2.

Here, an example in which a bracelet is attached to a right front leg and a posture in which the right front leg is raised is taken as a specific posture to be taken at the time of detecting the state change will be described.

As shown in FIG. 3, when the state change detection is started, the actuators 17 are driven on the basis of pieces of control parameter information regarding the actuators 17 located at the respective joints and connections, which are associated with the specific posture of raising the right front leg and registered in the robot information database 11 in advance (S13). This causes the pet-type robot 1 to perform the behavior of raising the right front leg.

Next, the right front leg is imaged by the camera 16 on the basis of to the optical parameter of the camera 16 associated with the posture of raising the right front leg, and an image (comparison image) 82 shown in Part (A) of FIG. 5 is obtained by the image acquisition unit 4 (S14). This comparison image is image information of the pet-type robot 1 that has moved in accordance with reference image information, and the position and posture of the pet-type robot 1 displayed in the comparison image can be similar to the position and posture of the pet-type robot displayed in the reference image.

Part (A) of FIG. 5 shows an image in which a floor 60 is displayed on the background of the image and a right front leg 51 of the pet-type robot 1 is displayed on the right side of the image. The right front leg 51 includes a finger portion 51a and an arm portion 51b, and a bracelet 61 is attached to the arm portion 51b.

Next, the image information (comparison image information) of the acquired comparison image is compared with reference image information associated with the posture of raising the right front leg registered in the robot information database 11 to take a difference (S15), and the region where the state has changed is detected.

In detail, as shown in Part (B) of FIG. 5, an image 83 obtained by cutting out a robot region, here, the region of the right front leg 51, from the comparison image 82 is acquired by superimposing the comparison image 82 shown in Part (A) of FIG. 5—and the mask image 80 of the reference image shown in Part (A) of FIG. 4. Alternatively, the robot region may be extracted using a segmentation result of pixels belonging to the robot region registered in advance.

Then, a region in which the bracelet 61 that does not exist in the reference image acquired in advance is attached as in an image 84 shown in FIG. 5C is extracted as a region where the state has changed by comparing the image 83 from which the robot region has been cut out with the RGB image 81 shown in Part (B) of FIG. 4 to take the difference. The comparison between the image 83 from which the robot region has been cut out and the RGB image 81 can be made on the basis of whether or not the difference value of the images exceed a threshold value.

The pet-type robot 1 recognizes, in the case where a target object (here, a bracelet) has been registered in the database in advance, that the region where the state has changed is the bracelet 61 by object recognition processing referring to the object information database (not shown) on the basis of the image of the region where the state has changed (the region where the bracelet 61 exists) shown in Part (C) of FIG. 5.

In the case where the pet-type robot 1 cannot recognize an object in the region where the state has changed, the extracted object (object in the region where the state has changed) may be stored in association with information such as the season and date and time when the comparison image has been acquired, weather, and an utterance and expression of a user, comparison image information, or the like.

This makes it possible to acquire correlation information such as information indicating that a user is glad when this object is attached, and the pet-type robot 1 can perform, in a situation in which a similar object is mounted thereafter, an action to express pleasure to the user.

Further, as another example, in the case where correlation information indicating that a certain object is attached in Christmas is acquired, it is possible to perform an action such as singing a Christmas song in a situation in which the object is attached.

Further, the pet-type robot 1 may recognize the colors, patterns, and the like of the object existing in the region where the state has changed, and perform an action on the basis of the result of recognizing the colors or patterns. For example, in the case where the color of the object is the color that the pet-type robot 1 likes, an action such as shaking the tail to express pleasure may be performed.

A user may be arbitrarily set the color that the pet-type robot 1 likes in the default setting. Alternatively, the user's favorite color may be set as the color that the pet-type robot 1 likes. For example, the pet-type robot 1 may determine, on the basis of information regarding the user, which is accumulated by the pet-type robot 1 living with the user, such as information regarding the clothing, ornaments, and personal belongings of the user, the most commonly used color as the user's favorite color, and use that color as the color that the pet-type robot 1 likes.

Thus, the state change such as whether or not an accessory has been attached can be detected by comparing the reference image information associated with a specific posture with the image information of the comparison image of a part of the own body taken using the camera 16 mounted on the pet-type robot 1 in the same position and posture as those when this reference image information has been acquired.

(Action Example of Pet-Type Robot)

Hereinafter, an action example of pet-type robot when attachment of an accessory is detected will be described, but the present technology is not limited to those described herein. The action information described below is registered in the action database 12.

The pet-type robot 1 performs an action with an increased degree of pleasure when an accessory of its favorite color is attached to the pet-type robot 1. Further, the pet-type robot 1 identifies the person who has been detected when an accessory is attached, and performs an action that the degree of fondness to the person is increased assuming that the accessory is given by the person.

The pet-type robot 1 performs, in the case where a favorite coordinate such as combinations of characteristic accessories is made, a special action that is not normally performed.

The pet-type robot 1 performs, when Santa clothing such as a red hat, shoes, and a white bag is attached, an action such as singing Christmas songs, playing Christmas songs, hiding presents behind a Christmas tree, and being desired to give its favorite items such as bones to the user.

When a sports uniform is attached, the pet-type robot 1 performs the form of the sports. Further, when an accessory including logo information regarding a baseball team and a club team is attached, the pet-type robot 1 performs an action according to the baseball team or the club team, such as movement when cheering for the baseball team or the club team.

The pet-type robot 1 performs, when an animal-mimicking accessory, such as a cat-ear accessory, a lion-mane accessory, and a costume, is attached, an action corresponding to the animal. For example, when a lion-mane accessory is attached, the pet-type robot 1 performs an action that reflects the emotion of anger. When a cat-ear accessory is attached, the pet-type robot 1 pronounces “meow”.

As described above, the pet-type robot 1 according to this embodiment detects a state change by moving itself without electrically or physically connecting. Then, the pet-type robot 1 performs an action corresponding to the state change, it is possible to perform natural interaction with a user.

### Second Embodiment

In the first embodiment, the comparison image used for state-change-detection processing is one obtained by directly imaging a part of the pet-type robot 1 with the camera 16 mounted on the pet-type robot 1, but the present technology is not limited thereto.

For example, a pet-type robot may acquire a comparison image by imaging itself displayed in a mirror by a camera mounted thereon as in this embodiment. In this case, prior to the state-change-detection processing, self-detection processing that detects whether or not a pet-type robot to be displayed in a mirror is itself is performed.

A second embodiment will be described below. Components similar to those of the above-mentioned embodiment are denoted by similar reference symbols, description thereof is omitted in some cases, and differences will be mainly described.

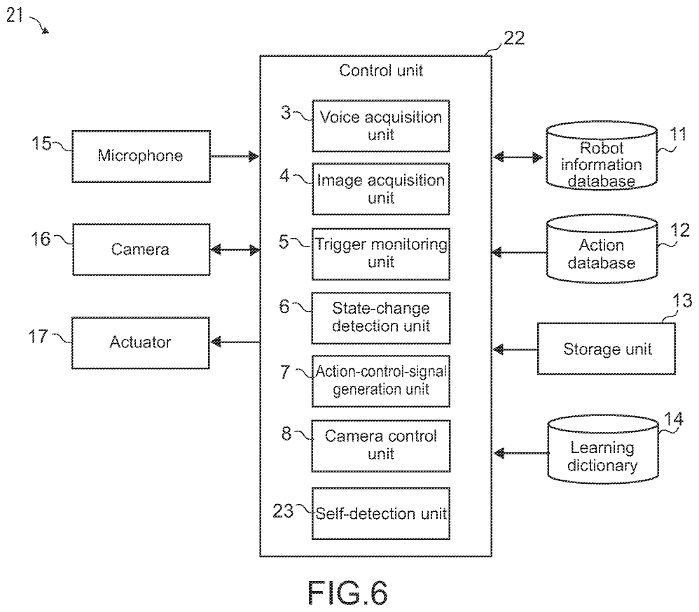

FIG. 6 shows a block diagram of the pet-type robot 21 as the autonomously acting robot according to this embodiment.

The pet-type robot 21 as information processing apparatus includes a control unit 22, the microphone 15, the camera 16, the actuator 17, the robot information database (DB) 11, the action database (DB) 12, the storage unit 13, and a learning dictionary 14.

The control unit 22 performs control relating to self-detection processing and state-change-detection processing.

In the self-detection processing, when a robot of the same type as the pet-type robot 21 is detected, whether or not the detected robot is the pet-type robot 21 is detected.

In the state-change-detection processing, whether or not to perform the state-change-detection processing is determined similarly to the first embodiment. In this embodiment, when it is determined in the self-detection processing that the detected robot is the pet-type robot 21 (itself), the state-change-detection processing is performed.

The control unit 22 includes the voice acquisition unit 3, the image acquisition unit 4, the trigger monitoring unit 5, the state-change detection unit 6, the action-control-signal generation unit 7, the camera control unit 8, and a self-detection unit 23.

The trigger monitoring unit 5 monitors occurrence or non-occurrence of a trigger that is a trigger of starting the state change detection of the pet-type robot 21. Examples of the trigger include detection of a robot of the same type as the pet-type robot 21 in addition to an utterance from a user, a certain predetermined elapsed time, and image information of the shadow of the pet-type robot 21 shown in the first embodiment.

Here, an example in which the trigger monitoring unit 5 monitors occurrence or non-occurrence of a trigger on the basis of detection of a robot of the same type as the pet-type robot 21 will be described. The trigger monitoring unit 5 determines, when a robot of the same type as the pet-type robot 21, such as a robot of a mirror image of the pet-type robot 21 displayed in a mirror and a pet-type robot of the same type other than the pet-type robot 21, is detected, that a trigger has occurred.

The trigger monitoring unit 5 uses the learning dictionary 14 to execute the detection of a robot of the same type. The learning dictionary 14 stores information such as a feature point and feature amount used to determine whether or not the robot displayed in the image acquired by the pet-type robot 21 is the robot of the same type as the pet-type robot 21 itself, and coefficients of models obtained by machine-learning.

When the trigger monitoring unit 5 detects a robot of the same type as the pet-type robot 21 and determines that a trigger has occurred, the self-detection unit 23 performs self-detection processing that detects whether or not the detected robot of the same type is the pet-type robot 21 (itself).

In detail, first, the self-detection unit 23 acquires a first image acquired by imaging the detected robot of the same type. After that, the self-detection unit 23 acquires a second image obtained by imaging the pet-type robot 21 in a posture different from that when the first image has been acquired.

Next, the self-detection unit 23 detects the movement of the robot of the same type from the first image and the second image, and determines whether or not the movement coincides with the movement of the pet-type robot 21.

When the movement of the robot of the same type does not coincide with the movement of the pet-type robot 21, the self-detection unit 23 determines that the detected robot of the same type is not the pet-type robot 21 (itself).

When the movement of the robot of the same type coincides with the movement of the pet-type robot 21 in a mirror-symmetrical positional relation, the self-detection unit 23 determines that the detected robot of the same type is a mirror image of the pet-type robot 21 displayed in a mirror, i.e., itself.

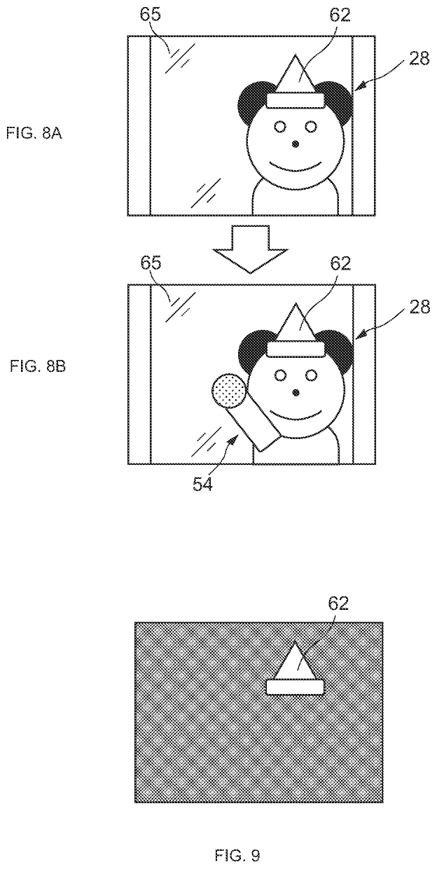

FIG. 8 is a diagram describing an example of self-detection processing when a robot 28 of the same type is detected in a mirror 65.

First, as shown in Part (A) of FIG. 8A, the detected robot 28 of the same type is imaged by the camera 16 of the pet-type robot 21 to acquire the first image. The pet-type robot 21 is in a posture of lowering both front legs at the time when the first image is obtained.

After that, the pet-type robot 21 changes its position by raising its left front leg. As shown in Part (B) of FIG. 8, the detected robot 28 of the same type is imaged by the camera 16 of the pet-type robot 21 to acquire the second image when this posture is changed.

By comparing the two images before and after the change of the posture of the pet-type robot 21, the movement of the robot 28 of the same type is extracted. Then, when this movement coincides with the movement of the pet-type robot 21 itself in a mirror-symmetrical positional relationship, the robot 28 of the same type displayed in the mirror 65 is determined to be a mirror image of the pet-type robot 21.

Meanwhile, when the movement of the robot 28 of the same type in the image does not coincide with the movement of the pet-type robot 21, it is determined that the detected robot 28 of the same type is another robot and is not the pet-type robot 21.

Such a posture change behavior may be performed multiple times to improve the detection accuracy of whether or not the detected robot of the same type is itself on the basis of the detection result. Note that although the raising and lowering of the left front leg is exemplified as an example of the posture change behavior here, the present technology is not limited thereto, and for example, a posture change behavior of moving right and left may be used.

The action-control-signal generation unit 7 generates, for self-detection processing, an action control signal of the behavior that the pet-type robot 21 changes its posture.

The action-control-signal generation unit 7 generates, for state-change-detection processing, an action control signal of the pet-type robot 1 so that the pet-type robot 21 is in the same position and posture as those in the reference image.

Further, the action-control-signal generation unit 7 selects an action model from the action database 12 to generate an action control signal of the pet-type robot 1 on the basis of the state-change-detection result detected by the state-change detection unit 6.

Information relating to the pet-type robot 21 is registered in the robot information database 11. Specifically, as information relating to the pet-type robot 1, control parameter information of the actuator 17 when the pet-type robot 21 has taken a certain posture, information of a reference image (reference image information) obtained by imaging the pet-type robot 21 that has taken the certain posture displayed in a mirror by itself by the camera 16 mounted thereon, and sensor information such as optical parameter information of the camera 16 when capturing the reference image are registered in association with each other for each different posture.

Here, the case where the reference image information is information when no accessory is attached to the pet-type robot 21, which has been registered at the time of shipment, will be described as an example.

(Outline of Processing Method Relating to State Change Detection)

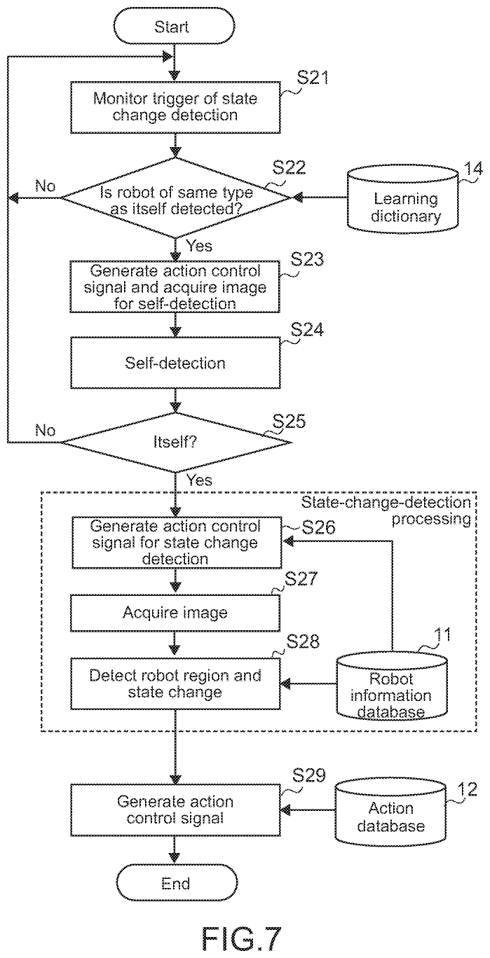

Next, a processing method relating to state change detection will be described with reference to FIG. 7 to FIG. 9. FIG. 7 is a flowchart of a series of processes relating to state change detection. FIG. 9 is a diagram for describing state-change-detection processing.

Here, a case where a hat is attached to a head potion will be exemplified, and a case where it is determined that the pet-type robot 21 itself displayed in a mirror is a robot of the same type will be described. Further, a posture of lowering both front legs will be described as an example of the specific posture to be taken by the pet-type robot 21 at the time of detecting the state change.

As shown in FIG. 7, monitoring by the trigger monitoring unit 5 is performed (S21), and the learning dictionary 14 is used to determine whether or not a robot of the same type as the pet-type robot 21 has been detected in the image taken by the camera 16 (whether or not a trigger has occurred) (S22).

When it is determined in S22 that the robot of the same type has not been detected (No), the processing returns to S21.

When it is determined in S22 that the robot 28 of the same type has been detected (Yes), the processing proceeds to S23.

In S23, generation of an action control signal and acquisition of an image for self-detection are performed. As a specific example, an action control signal is generated so as to take a posture of raising the left front leg from a posture of lowering both front legs, and the pet-type robot 21 takes a posture of raising its left front leg on the basis of this signal. In the state where the posture of the pet-type robot 21 has changed, the second image of the robot 28 of the same type is acquired.

Next, the self-detection unit 23 compares the first image at the time of detecting the robot 28 of the same type, which is an image before the posture change, with the second image of the robot 28 of the same type acquired at the time of the posture change of the pet-type robot 21, and self-detection is performed to determine whether or not the movement of the robot 28 of the same type in the image coincides with the movement of the pet-type robot 21 (S24).

Next, whether or not the detected robot 28 of the same type is the pet-type robot 21 on the basis of the detection result in S24 (S25).

When it is determined that the detected robot of the same type is not the pet-type robot 21 but another robot (No) on the basis of the detection result that the movement performed by the robot 28 of the same type in the image and the movement performed by the pet-type robot 21 do not coincide with each other in the mirror-symmetrical positional relationship, the processing returns to S21.

Here, when it is determined that the robot 28 of the same type is another robot, the state-change-detection processing may be executed by the robot 28 of the same type. In this case, the pet-type robot 21 may image the robot 28 of the same type and send the obtained image to the robot 28 of the same type, thereby making it possible for the robot 28 of the same type to be capable of specifying which robot is to perform the state-change-detection processing.

Meanwhile, when it is determined that the detected robot 28 of the same type is the pet-type robot 21 (Yes) on the basis of the detection result that the movement performed by the robot 28 of the same type in the image and the movement performed by the pet-type robot 21 coincide with each other in the mirror-symmetrical positional relationship, the processing proceeds to S26. In S26 and subsequent Steps, the state-change-detection processing is performed.

In S26, an action control signal for state change detection is generated.

Specifically, an action control signal of the pet-type robot 21 is generated so that the pet-type robot 21 is located at the same position as that of the pet-type robot in the reference image associated with the posture of lowering both front legs registered in the robot information database 11 in an image obtained by imaging the pet-type robot 21 displayed in the mirror 65 by the camera 16. The pet-type robot 21 moves on the basis of this action control signal. As a result, the pet-type robot 21 takes a position and posture similar to those in the reference image.

Next, the pet-type robot 21 that is displayed in the mirror 65 and has taken the same position and posture as those of the pet-type robot in the reference image is imaged by the camera 16 set to an optical parameter similar to the optical parameter of the camera associated with the posture of lowering both front legs to acquire image information of the comparison image (S27).

Next, the state-change detection unit 6 compares the reference image information and comparison image information that are associated with the posture of lowering both front legs, the robot region and the region where the state has changed are extracted, and the region of a hat 62 is detected as the region where the state has changed as shown in FIG. 9 (S28).

By using the camera 16 mounted on the pet-type robot 21 to compare the comparison image information of the pet-type robot displayed in a mirror with the reference image information registered in the robot information database 11 as described above, it is possible to detect whether or not an accessory has been attached.

Note that here, a mirror is exemplified as a member that displays an object using specular reflection of light, but glass, a water surface, or the like may be used instead of the mirror.

As described above, the pet-type robot 21 according to this embodiment detects a state change by moving itself without electrically or physically connecting. Then, since the pet-type robot 21 performs the action corresponding to the state change, it is possible to perform natural interaction with a user.

### Third Embodiment

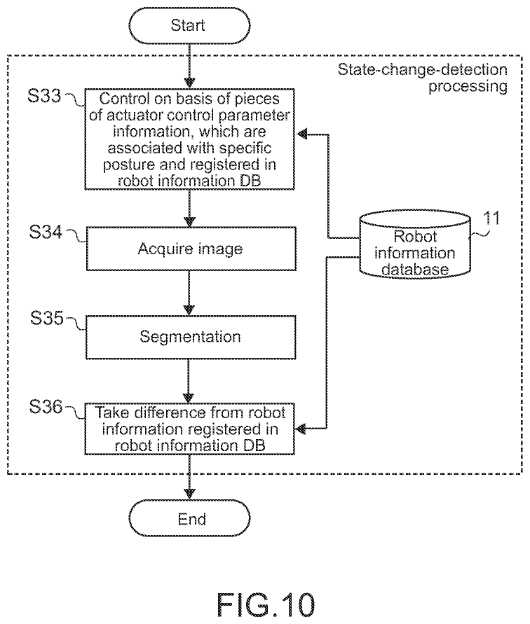

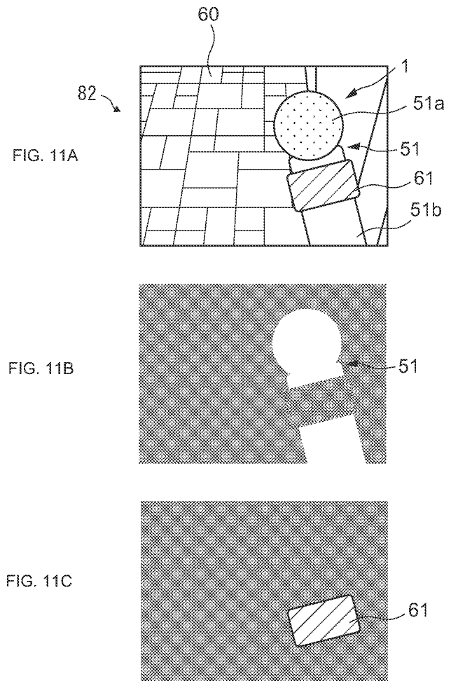

In the above-mentioned embodiments, segmentation may be used for the state-change-detection processing, and will be described below with reference to FIG. 10 and FIG. 11. Here, similarly to the first embodiment, a case where the right front leg, which is a part of the body of the pet-type robot 1, is directly imaged using the camera 16 mounted thereon will be described as an example. Further, components similar to those of the above-mentioned embodiments are denoted by similar reference symbols, and description thereof is omitted in some cases.

Note that the state-change-detection processing in this embodiment is applicable also to the second embodiment using image information of a robot displayed in a mirror.

FIG. 10 is a flowchart showing a specific example of the state-change-detection processing. FIG. 11 is a diagram showing an example of the state-change-detection processing using segmentation.

The reference image information to be registered in the robot information database 11 includes segmentation information of pixels belonging to the robot region.

As shown in FIG. 10, when state change detection is started, the actuators 17 are driven on the basis of pieces of control parameter information of the actuators 17 located at the respective joints and connections, which are associated with the specific posture of raising the right front leg and registered in the robot information database 11 in advance (S33). This causes a pet-type robot 31 to perform the behavior of raising the right front leg.

Next, the right front leg is imaged by the camera 16 on the basis of the optical parameter of the camera 16 associated with the posture of raising the right front leg, and an image (comparison image) S2 captured by the camera 16 shown in Part (A) of FIG. 11 is acquired by the image acquisition unit (S34).

Part A of FIG. 11 shows an image in which the floor 60 is displayed on the background of the image and the right front leg 51 of the pet-type robot 1 is displayed on the right side of the image. The right front leg 51 includes the finger portion 51a and the arm portion 51b, and the bracelet 61 is attached to the arm portion 51b.

Next, segmentation in which regions are grouped into groups having a similar feature amount in the comparison image 82 and divided into a plurality of regions is performed (S35). As a result, as shown in Part (B) of FIG. 11, a robot region in which the bracelet 61 is not located is extracted from the right front leg 51.

For the segmentation, a clustering method is typically used. Since the image corresponding to the object displayed in the image has similar features in color, brightness, and the like, the image can be segmented into regions corresponding to the object by clustering the pixels. Supervised clustering which gives a correct answer to the clustering of pixels as the supervised data may be used.

Next, the difference between segmentation information of the acquired comparison image and pixel segmentation information for determining the robot region associated with the posture of raising the right front leg registered in the robot information database 11 is taken (S 36), and a region where the bracelet 61 is attached and the state has changed as shown in Part (C) of FIG. 11 is detected.

As described above, the state-change-detection processing may be performed using segmentation.

### Fourth Embodiment

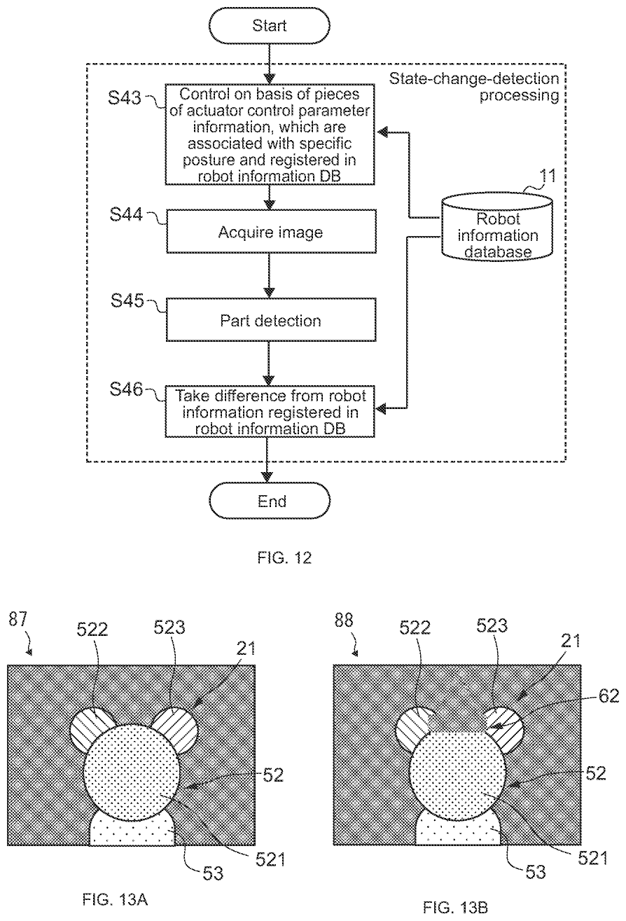

Part detection may be used for the state-change-detection processing, and will be described below with reference to FIG. 12 and FIG. 13. Here, a case where image information of the robot 21 displayed in the mirror is used similarly to the second embodiment will be exemplified. Further, components similar to those of the above-mentioned embodiments are denoted by similar reference symbols, and description thereof is omitted in some cases.

Note that condition detection processing in this embodiment is applicable also to the first embodiment in which the pet-type robot 1 directly images a part of the body of the pet-type robot 1 itself using the camera 16 mounted thereon.

The pet-type robot 1 includes a plurality of parts such as a body portion, a finger portion of a right front leg portion, an arm portion of the front leg portion, a finger portion of a left front leg portion, an arm portion of the left front leg portion, a finger portion of a right rear leg, a thigh portion of the right rear leg, a finger portion of a left rear leg, a thigh portion of the left rear leg, a face portion, a right ear portion, a left ear portion, and a tail portion.

FIG. 12 is a flowchart showing a specific example of the state-change-detection processing.

FIG. 13 is a diagram of a reference image 87 in which a robot region of the image of the pet-type robot 21 is displayed so as to be distinguishable for each body part by segmentation.

Part (A) of FIG. 13 shows a state in which an accessory is not attached, and Part (B) of FIG. 13 shows a state in which a hat is attached as an accessory. Any of the figures shows an image obtained by imaging the pet-type robot 1 displayed in the mirror.

In the robot information database 11, reference image information obtained by imaging the pet-type robot 21 displayed in a mirror when an accessory is not attached by the camera 16 of the pet-type robot 21 itself, control parameter information of the actuator 17, which defines the posture or the like of the pet-type robot 1 when this reference image information is acquired, and sensor information of the camera 16 or the like are registered in association with each other.

The reference image information registered in the robot information database 11 includes segmentation information of pixels belonging to the robot region. This segmentation information includes pixel segmentation information for each part that can be distinguished from each other.

In the part detection, each part can be distinguished by the registered pixel segmentation for each part of the body of the pet-type robot 21.

Part (A) of FIG. 13 shows the reference image 87 including pixel segmentation information for distinguishing each part of the robot region. In the reference image 87, the upper body of the pet-type robot 1 is displayed. In the diagram shown in Part (A) of FIG. 13, the pet-type robot 1 is divided into parts such as a body portion 53, a face portion 521, a right ear portion 522 in the mirror image, and a left ear portion 523 in the mirror image. Pixel segmentation information of each of these parts is registered in the robot information database 11.

As shown in FIG. 12, when state change detection is started, an action control signal is generated so that the position and posture of the pet-type robot 1 displayed in the mirror on the image coincide with those in the reference image registered in the robot information database 11, and the actuator 17 is driven (S43) on the basis of this. This causes the pet-type robot 31 to perform the behavior of raising the right front leg.

Next, the pet-type robot 21 displayed in the mirror is imaged by the camera 16, and a comparison image is acquired by the image acquisition unit 4 (S44).

Next, part detection of the robot region is performed in the comparison image (S45). In the part detection, segmentation in which regions are grouped for each group having similar feature amount in the comparison image and divided into a plurality of regions is performed. As a result, as shown in Part (B) of FIG. 13, a comparison image 88 including segmentation information in which a robot region is extracted by dividing regions into regions that can be distinguished for each part is obtained as comparison image information.

Next, the difference between the comparison image 88 and the reference image 87 including pixel segmentation information for determining each part of the robot region registered in the robot information database 11 is taken (S46). As a result, in which part a state change has occurred is detected, and the region where the state change has occurred is detected.

As described above, in which part a state change has occurred may be detected by using the part detection.

### Fifth Embodiment

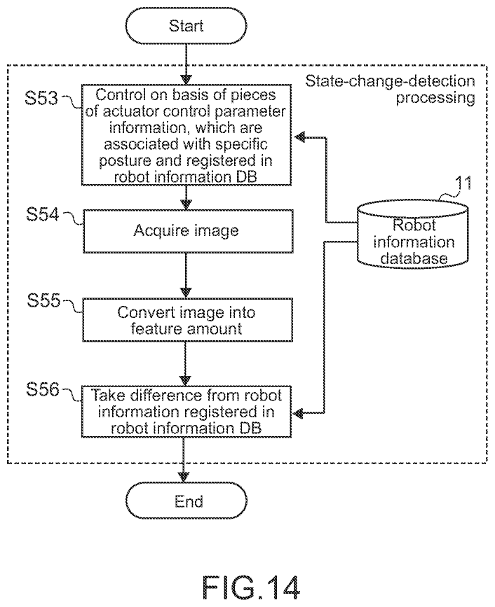

In the first and second embodiments, a feature amount may be used for the state-change-detection processing, and will be described below with reference to FIG. 14. Here, a case where the pet-type robot 1 directly images the raised right front leg by using the camera 16 mounted thereon similarly to the first embodiment will be described as an example. Further, components similar to those of the above-mentioned embodiments are denoted by similar reference symbols, and description thereof is omitted in some cases.

Note that the state-change-detection processing in this embodiment is applicable to the second embodiment using image information of a robot displayed on a mirror.

FIG. 14 is a flowchart showing a specific example of the state-change-detection processing.

The reference image information registered in the robot information database 11 includes a feature amount of the reference image.

As shown in FIG. 14, when the state change detection is started, the actuators 17 are driven on the basis of control parameter information of the actuators 17 located at the respective joints and connections associated with a specific posture of raising the right front leg, which is registered in the robot information database 11 in advance (S53). This causes the pet-type robot 31 to perform the behavior of raising the right front leg.

Next, the right front leg is imaged by the camera 16 on the basis of the optical parameter of the camera associated with the posture of raising the right front leg, and a comparison image is acquired by the image acquisition unit 4 (S54).

Next, a comparison image is converted into a feature amount (S55).

Next, the difference between the feature amount of the comparison image as the acquired comparison image information and the feature amount of the reference image associated with the posture of raising the right front leg registered in the robot information database 11 is taken (S56) to detect a region where the state has changed.

In this manner, the position and posture of the robot region displayed in the comparison image can be identified by matching the image feature amount.

### Sixth Embodiment

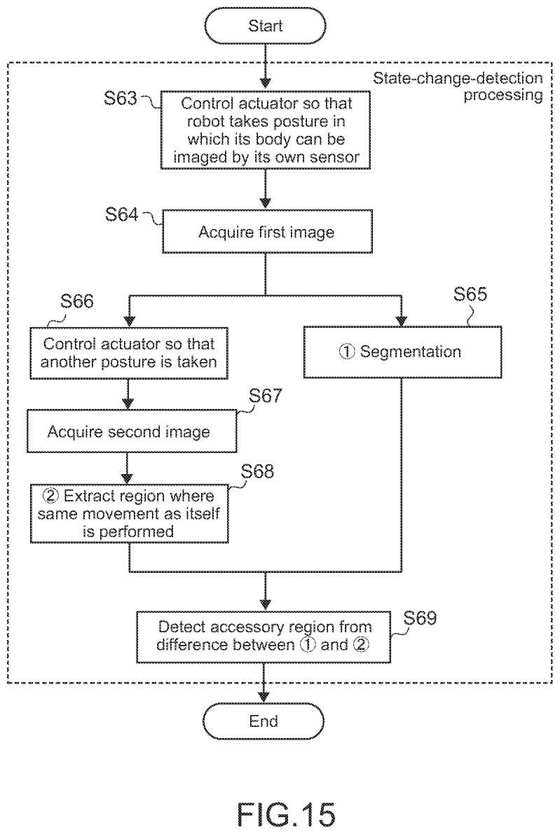

In the first to fifth embodiments, state-change-detection processing has been performed using the difference from the reference image information registered in the robot information database. However, state-change-detection processing can also be performed without using the difference from image information registered in the database. Hereinafter, description will be made by using FIG. 15. FIG. 15 is a flowchart of state-change-detection processing.

Here, a case in which the pet-type robot 1 directly images a part of the body of the pet-type robot 1 itself using the camera 16 mounted thereon similarly to the first embodiment will be described as an example. Further, an example in which an accessory is attached to the right front leg will be described. In this embodiment, a state change from the state where no accessory is attached is detected.

As shown in FIG. 15, when state change detection is started, an action control signal of the pet-type robot 1 is generated so that the pet-type robot 1 takes a posture in which the body of the pet-type robot 1 itself can be imaged using the camera 16 mounted thereon, and the actuator 17 is driven on the basis of this (S63). Here, an action control signal is generated so that the pet-type robot 1 takes a posture in which the right front leg can be imaged.

Next, the right front leg is imaged by the camera 16, and the first image is acquired by the image acquisition unit 4 (S64).

Next, segmentation in which regions are grouped into groups having a similar feature amount in the image and divided into a plurality of regions is performed on the first image (S65), and a robot region is extracted. This information does not include an accessory region.

Next, an action control signal of the pet-type robot 1 is generated so that the pet-type robot 1 takes a posture in which the body of the pet-type robot 1 itself can be imaged using the camera 16 mounted thereon, which is different from the posture taken in S63, and the actuator 17 is driven on the basis of this (S66).

Next, the right front leg is imaged by the camera 16, and the second image is acquired by the image acquisition unit 4 (S67).

Next, the first image and the second image are compared with each other to extract a region where the same movement as that of the pet-type robot 1 is performed (S68). When the pet-type robot 1 moves while an accessory is attached, the accessory moves in conjunction with the movement of the pet-type robot 1. Therefore, the region extracted in S68 is a region that performs the same movement, is estimated to be a region in which a robot exists, and includes an accessory region and a robot region in this embodiment.

The pieces of image information of the first image, the second image, the robot region extracted using these images, an accessory region, and the like correspond to comparison image information.

Next, an accessory region is detected from the difference between the region including the accessory and the robot extracted in S68 and the robot region extracted in S65 (S69). This accessory region corresponds to a state-change region when compared with reference image information in which no accessory is attached.

Here, although the region including an accessory and a robot is extracted from the movement difference in S68, the background difference may be used. In this case, an image of only the background may be acquired so that the body of the pet-type robot 1 is not imaged, and an accessory region and a robot region may be extracted from the image of only the background and an image captured so that the same background as this background and the right front leg are included.

### Seventh Embodiment

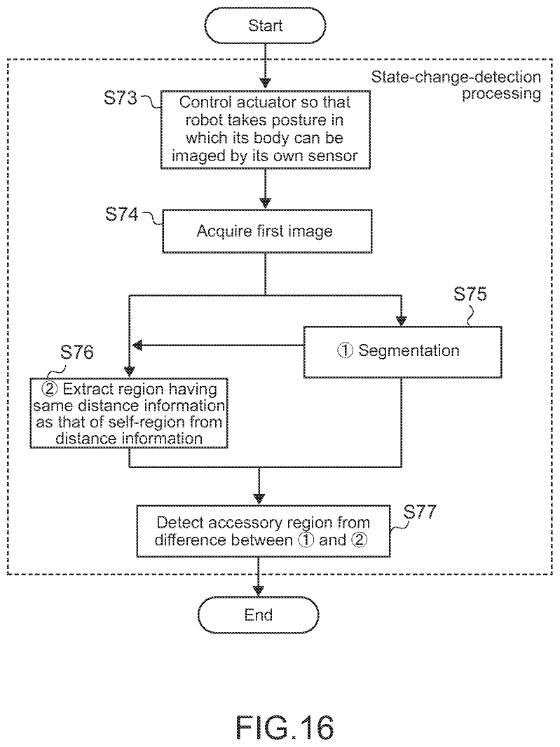

Another example of performing state-change-detection processing without using the difference from the reference image information registered in the robot information database will be described with reference to FIG. 16. FIG. 16 is a flowchart of the state-change-detection processing.

Here, a case where the pet-type robot 1 directly images a part of the body of the pet-type robot 1 itself using the camera 16 mounted thereon similarly to the first embodiment will be described. Further, an example where an accessory is attached to the right front leg will be described. Also in this embodiment, a state change from state where no accessory is attached is detected.

The pet-type robot 1 includes a depth sensor. For example, infrared light can be used to sense the distance from the sensor to the object by obtaining a depth image indicating the distance from the depth sensor at each position in space. As the depth sensor system, an arbitrary system such as a TOF (Time of flight) system, patterned illumination system, and stereo camera system can be adopted.

As shown in FIG. 16, when state change detection is started, an action control signal of the pet-type robot 1 is generated so that the pet-type robot 1 takes a posture in which the body of the pet-type robot 1 itself can be imaged using the camera 16 mounted thereon, and the actuator 17 is driven on the basis of this (S73). Here, an action control signal is generated so that the pet-type robot 1 takes a posture in which the right front leg can be imaged.

Next, the right front leg is imaged by the camera 16, and an image is acquired by the image acquisition unit 4 (S74).

Next, segmentation in which regions are grouped into groups having a similar feature amount in image and divided into a plurality of regions is performed on the image acquired in S74 (S75) to extract a robot region. This information of the robot region does not include an accessory region.

Next, the depth sensor acquires distance information. A region having the same distance information as that of the robot region extracted in S75 is extracted from this distance information (S76). The extracted region includes an accessory region and a robot region.

The pieces of image information of the image acquired in S74, the robot region extracted using this image, the accessory region, and the like correspond to the comparison image information.

Next, an accessory region is detected from the difference between the region extracted in S76 and the region extracted in S75 (S77). This accessory region corresponds to a state-change region when compared with reference image information in which no accessory is attached.

In this embodiment, an example in which a part of the body of the pet-type robot itself is directly imaged by the camera mounted thereon has been described. However, the processing using the depth sensor can be performed also when a pet-type robot displayed in a mirror is imaged.

In this case, it is better to use a stereoscopic-camera-type depth sensor instead of the TOF-type and pattern-illumination-type depth sensors that allow only the distance between the pet-type robot and the mirror to be used. The distance information may be obtained using a stereoscopic-camera-type depth sensor mounted on the pet-type robot, or can be obtained by stereo matching using images taken from two different viewpoints on the basis of self-position estimation by SLAM (Simultaneous Localization and Mapping).

Further, the depth image may be used for state-change-detection processing using the difference from the robot information database.

### Eighth Embodiment

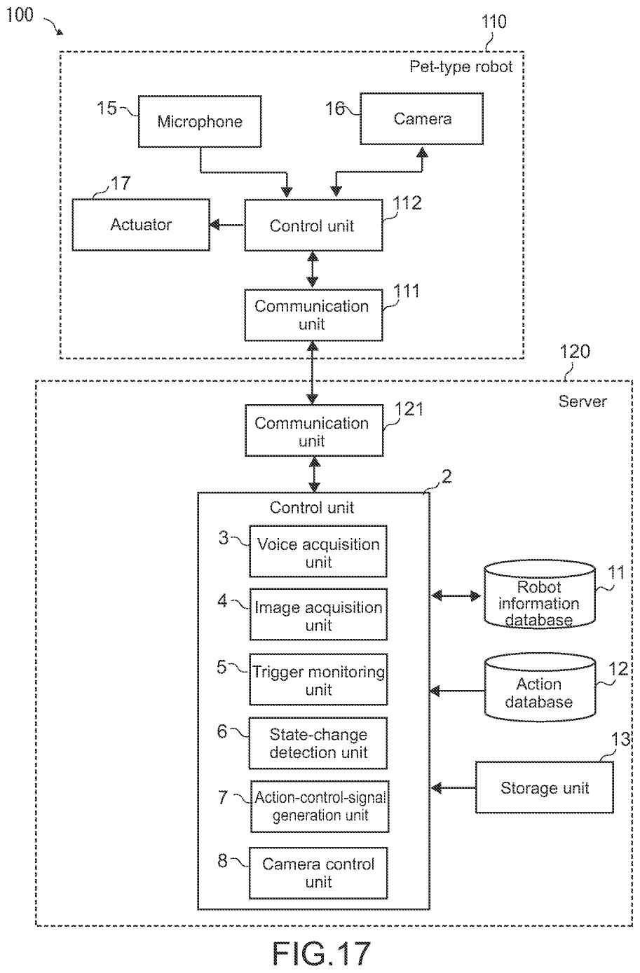

Although an example in which state-change-detection processing is performed on the side of the pet-type robot has been described in the above-mentioned embodiments, the state-change-detection processing may be performed on the cloud server. Hereinafter, although description will be made with reference to FIG. 17, components similar to those in the above-mentioned embodiments will be denoted by similar reference symbols, and description thereof is omitted in some cases.

FIG. 17 is a diagram describing an information processing system 100 according to this embodiment, and is a block diagram showing configurations of a server 120 as an information processing apparatus and a pet-type robot 110 as an autonomously acting robot. Here, only the configuration necessary for describing this embodiment is shown.

As shown in FIG. 17, the information processing system 100 includes the pet-type robot 110 and the server 120. The pet-type robot 110 and the server 120 are configured to be capable of communicating with each other.

The pet-type robot 110 includes the microphone 15, the camera 16, the actuator 17, and a communication unit 111, and a control unit 112.

The communication unit 111 communicates with the server 120. The control unit 112 drives the actuator 17 on the basis of an action control signal transmitted from the server 120 via the communication unit 111. The control unit 112 controls the camera 16 on the basis of the optical parameter of the camera transmitted from the server 120 via the communication unit 111. The control unit 112 transmits, via the communication unit 111, image information of an image taken by the camera 16 and voice information of voice acquired by the microphone 15 to the server 120.

The server 120 includes a communication unit 121, the control unit 2, the storage unit 13, the robot information database 11, the action database 12, and the storage unit 13. The control unit 2 may include the self-detection unit 23 described in the second embodiment, and the same applies to the following ninth and tenth embodiments.

The communication unit 121 communicates with the pet-type robot 110. The control unit 2 performs control relating to the state-change-detection processing similarly to the first embodiment.

The control unit 2 performs state-change-detection processing using the image information and voice information transmitted from the pet-type robot 110 via the communication unit 121, and information in the robot information database 11.

The control unit 2 generates an action control signal of the pet-type robot 110 and a control signal of the camera 16 on the basis of the information registered in the robot information database 11, the result of state-change-detection processing result, and the information registered in the action database 12. The generated action control signal and the control signal of the camera are transmitted to the pet-type robot 110 via the communication unit 121.

### Ninth Embodiment

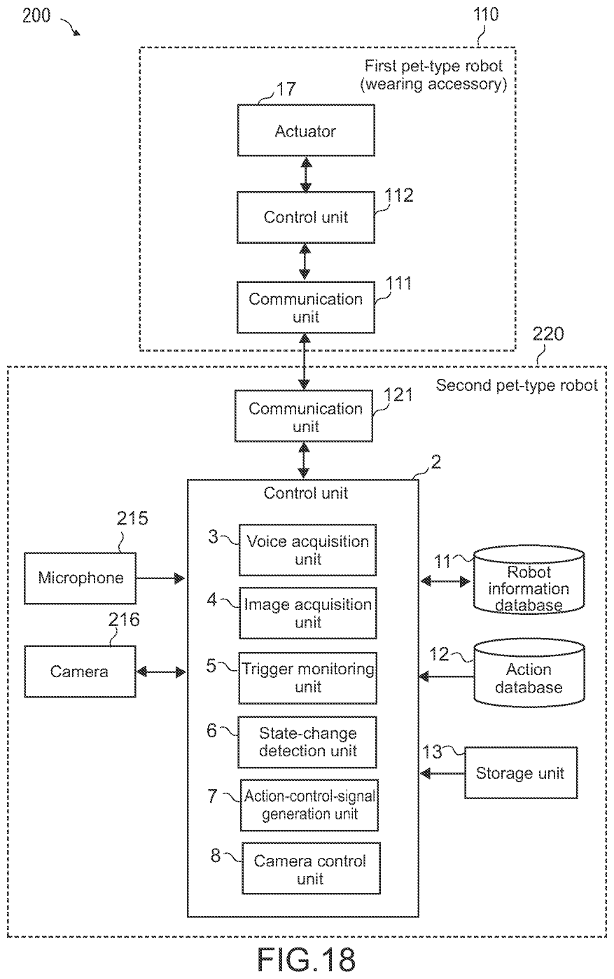

An example in which the state-change-detection processing is performed on the server side has been described in the eighth embodiment. However, a second pet-type robot different from the first pet-type robot to which accessory is attached may image the first pet-type robot and perform the state-change-detection processing. Hereinafter, although description will be made with reference to FIG. 18, components similar to those in the above-mentioned embodiments will be denoted by similar reference symbols, and description thereof is omitted in some cases.

FIG. 18 is a diagram describing an information processing system 200 according to this embodiment, and is a block diagram showing configurations of a first pet-type robot 110 as a first autonomously acting robot and a second pet-type robot 220 as a second autonomously acting robot. Here, only the configuration necessary for describing this embodiment is shown.

As shown in FIG. 18, the information processing system 200 includes the first pet-type robot 110 and the second pet-type robot 220 as an information processing apparatus. The first pet-type robot 110 and the second pet-type robot 220 may be the same type of robot or may be different types of robot.

In this embodiment, an accessory is attached to the first pet-type robot 110. The second pet-type robot 220 images the first pet-type robot 110 and further detects the state change of the first pet-type robot 110.

Here, since an example in which the first pet-type robot 110 is imaged by a camera 216 mounted on the second pet-type robot 220 will be described, the first pet-type robot 110 and the second pet-type robot 220 are in close positional relationship within a range in which the other party can be imaged.

The first pet-type robot 110 includes the actuator 17, the communication unit 111, and the control unit 112. The communication unit 111 communicates with the second pet-type robot 220. The control unit 112 drives the actuator 17 on the basis of the action control signal received from the second pet-type robot 220 via the communication unit 111.

The second pet-type robot 220 includes the communication unit 121, the control unit 2, the robot information database 11, the action database 12, the storage unit 13, a microphone 215, and the camera 216.

The communication unit 121 communicates with the first pet-type robot 110.

The camera 216 images the first pet-type robot 110. The image information of the captured image is acquired by the image acquisition unit 4.

The microphone 215 collects the voice surrounding the second pet-type robot 220. In this embodiment, since the first pet-type robot 110 and the second pet-type robot 220 are close together, the voice surrounding the first pet-type robot 110 can also be collected by the microphone 215. The information of the collected voice is acquired by the voice acquisition unit 3.

The control unit 2 performs processing relating to state-change-detection processing using the voice information and image information acquired from the microphone 215 and the camera 216, and the information registered in the robot information database 11, similarly to the first embodiment.

The control unit 2 generates an action control signal of the first pet-type robot 110, and a control signals of the camera 216 on the basis of the information registered in the robot information database 11, the results of the state-change-detection processing, and the information registered in the action database 12. The action control signal and the control signal of the camera are transmitted to the first pet-type robot 110 via the communication unit 121.

As described above, the second pet-type robot other than first pet-type robot to which an accessory is attached may acquire an image and perform the state-change-detection processing.

Further, acquisition of image information and voice information, and the state-change-detection processing, and the like may be executed by an AI (Artificial Intelligence) device, a mobile terminal, or the like that does not act autonomously and is fixedly disposed instead of the second pet-type robot.

Further, image information and voice information may be acquired using a camera and a microphone mounted on the side of the first pet-type robot to which an accessory is attached, and these pieces of information may be used to perform the state-change-detection processing by the second pet-type robot 220.

Further, the second pet-type robot 220 may acquire image information and voice information of the first pet-type robot 110 to which an accessory is attached, and these pieces of information may be used to perform the state-change-detection processing on the side of the first pet-type robot 110.

For example, the second pet-type robot 220, an AI device including a sensor, or the like may detect the first pet-type robot 110 and send sensor information such as image information and voice information acquired by the second pet-type robot 220 or the AI device to the detected the first pet-type robot 110, whereby the first pet-type robot 110 may use this sensor information to perform state-change-detection processing.

Note that the second pet-type robot 220, the AI device, or the like is capable of specifying the destination of the acquired sensor information (here, the first pet-type robot 110) by means of spatial maps, GPSs, inter-robot communication, or the like.

### Tenth Embodiment

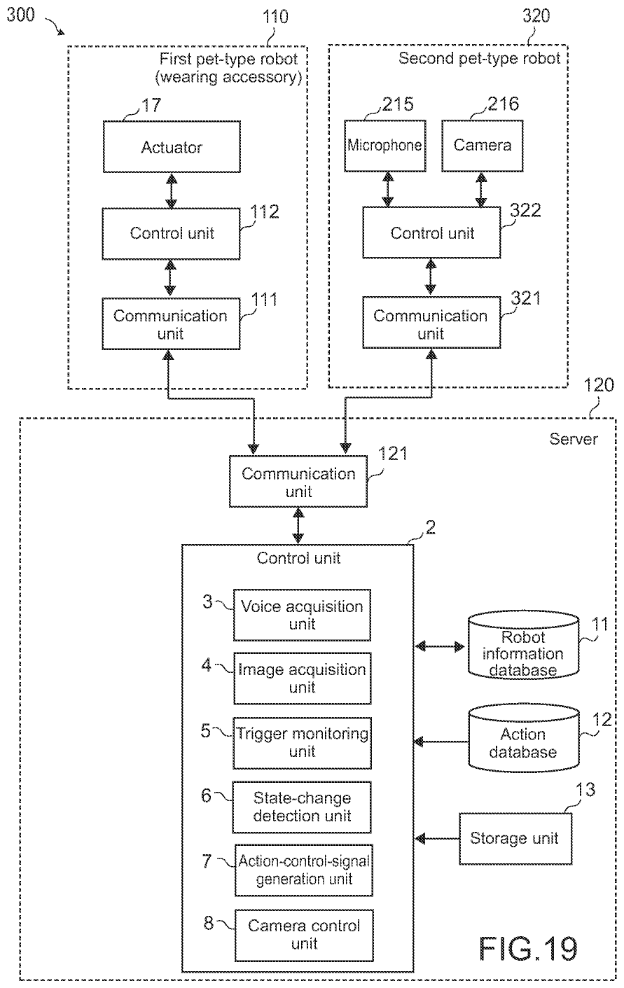

An example in which acquisition of an image and state-change-detection processing are executed by the second pet-type robot has been described in the ninth embodiment. However, a second pet-type robot different from the first pet-type robot to which an accessory is attached may image the first pet-type robot, and state-change-detection processing may be performed on the side of the cloud server. Hereinafter, although description will be made with reference to FIG. 19, components similar to those in the above-mentioned embodiments will be denoted by similar reference symbols, and description thereof is omitted in some cases.

FIG. 19 is a diagram describing an information processing system 300 according to this embodiment, and is a block diagram showing configurations of the first pet-type robot 110 as a first autonomously acting robot, a second pet-type robot 320 as a second autonomously acting robot, and the server 120. Here, only the configuration necessary for describing this embodiment is shown.

As shown in FIG. 19, the information processing system 300 includes the first pet-type robot 110, the second pet-type robot 320, and the server 120 as an information processing apparatus.

In this embodiment, an example in which an accessory is attached to the first pet-type robot 110, the second pet-type robot 320 images the first pet-type robot 110, and a state change is detected by the server 120 will be described. The first pet-type robot 110 and the second pet-type robot 320 are in close positional relationship within a range in which the other party can be imaged.

The first pet-type robot 110 includes the actuator 17, the communication unit 111, and the control unit 112. The communication unit 111 communicates with the server 120. The control unit 112 drives the actuator 17 on the basis of the action control signal received from the server 120 via the communication unit 111.

The second pet-type robot 320 includes a communication unit 321, a control unit 322, the microphone 215, and the camera 216. The communication unit 321 communicates with the server 120. The camera 216 images the first pet-type robot 110. The image information of the captured image is transmitted to the server 120 and acquired by the image acquisition unit 4.

The microphone 215 collects the voice surrounding the second pet-type robot 320. In this embodiment, since the first pet-type robot 110 and the second pet-type robot 320 are close together, the voice surrounding the first pet-type robot 110 can also be collected by the microphone 215. The information of the collected voice is transmitted to the server 120 and acquired by the voice acquisition unit 3.

The server 120 includes the communication unit 121, the control unit 2, the robot information database 11, the action database 12, and the storage unit 13.

The control unit 2 performs processing relating to state-change-detection processing similarly to the first embodiment by using the voice information and image information acquired from the second pet-type robot 320, and the information registered in the robot information database 11.

The control unit 2 generates an action control signal of the first pet-type robot 110 on the basis of the information registered in the robot information database 11, the results of the state-change-detection processing, and the information registered in the action database 12. The action control signal is transmitted to the first pet-type robot 110 via the communication unit 121.

Further, the control unit 2 generates a control signal of the camera 216 of the second pet-type robot 320 on the basis of the information registered in the robot information database 11. The control signal of the camera is transmitted to the second pet-type robot 320 via the communication unit 121.

As described above, a second pet-type robot other than the first pet-type robot to which an accessory is attached may acquire an image, and state-change-detection processing may be performed by a server different from these pet-type robots.

Note that image information and voice information may be acquired by an AI device, a mobile terminal, or the like that does not act autonomously instead of the second pet-type robot.

As described above, also in the eighth to tenth embodiments, the pet-type robot detects a state change by moving itself without electrically or physically connecting. Then, since the pet-type robot performs an action corresponding to the state change, it is possible to perform natural interaction with a user.

### Eleventh Embodiment

In the above-mentioned embodiments, as reference image information, an example in which image information in which no accessory is attached, which has been registered in the robot information database at the time of shipment and is used has been described, but the present technology is not limited to thereto.

That is, the state change detection may be performed by comparing the reference image information acquired at a certain time point with the comparison image information acquired at another time point (current time point) later than the certain time point.

For example, assuming that a red bracelet is attached to the right front leg at a certain time point and a blue bracelet is attached to the right front leg at another time point later than that, the state change that the red bracelet has been removed and the blue bracelet has been attached can be detected by comparing the pieces of image information acquired at the respective time points with each other.

Further, although an example in which the trigger monitoring unit 5 monitors occurrence or non-occurrence of a trigger by using the utterance of a user has been described in the above-mentioned embodiments, the trigger monitoring unit 5 may monitor occurrence or non-occurrence of a trigger by using a predetermined elapsed time.

As an example of monitoring a trigger by using the predetermined elapsed time, a trigger is set to occur at 14 p.m. each day so that a trigger occurs every 24 hours. In this manner, state-change-detection processing may be periodically performed by itself. Image information acquired every 24 hours is registered in the robot information database 11 in chronological order.

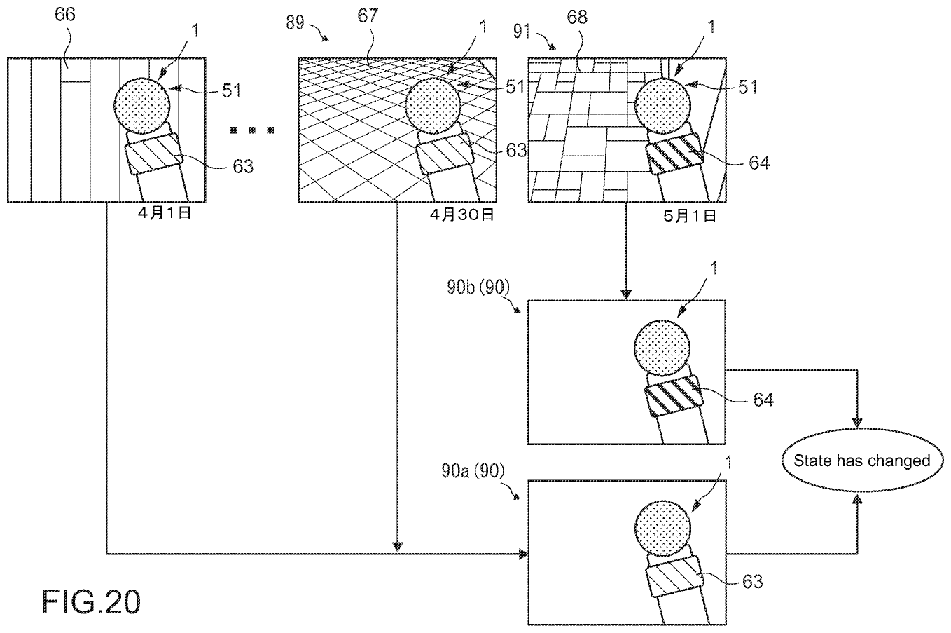

FIG. 20 shows a time-series arrangement of images obtained by directly imaging the right front leg of a pet-type robot using the camera mounted thereon with the same posture and optical parameter at 14:00 p.m. each day. FIG. 20 illustrates an example in which a thin hatched bracelet 63 is attached from April 1 to April 30 and a thick hatched bracelet 64 is attached on May 1.

By superimposing an image taken at the same time every day and a mask image of a reference image registered in the robot information database 11 from the time of shipment, an image 90 in which the robot region and accessory region are cut out is generated.

For example, in FIG. 20, an image 90a in which a robot region and an accessory region are cut out from an image 89 acquired from April 1 to April 30 is acquired. By accumulating or integrating images acquired in a certain period of time, for example, the image 90a can be used as self-normal-state information in the period of April 1 to April 30.

Then, an image 90b in which the robot region and accessory region are cut out from an image 91 acquired on May 1 is generated. By comparing the image 90b corresponding to the comparison image information with the image 90a corresponding to the reference image information, which is the self-normal-state information acquired immediately before this image 90b, an accessory region is detected as a state change area. As a result, it is detected as a state change that an accessory that has been attached for a certain period of time has been removed and another accessory has been attached.

Thus, by comparing the reference image information acquired at a certain time point with the comparison image information acquired at another time point later than that, a state change such as accessory removal and accessory attachment can be detected.

Further, by acquiring images at regular intervals, performing state-change-detection processing, and accumulating these pieces of information, it is possible to suppress occurrence of erroneous detection such as detection of a state change due to aging as attachment of an accessory.

That is, by performing state change detection regular intervals, since a state change can be detected by comparing the image information (reference image information) acquired immediately before with the current image information (comparison image information), it is possible to suppress occurrence of erroneous detection such as detection of a state change caused by a change in the color of a pet-type robot itself due to aging over a long period of time or a state change due to scratches or the like as attachment of an accessory.

### Twelfth Embodiment

The self-detection processing is not limited to the above-mentioned method in the second embodiment.

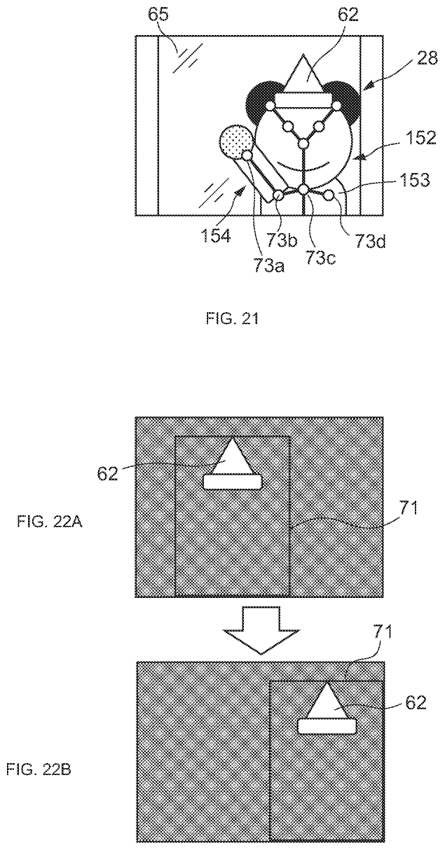

FIG. 21 is a diagram describing self-detection processing using a part point. As shown in FIG. 21, when the robot 28 of the same type is detected in self-detection processing, an image of the robot 28 of the same type is acquired, and a part point of the robot 28 of the same type is estimated from the image. The part point is located at a body part such as an eye, a nose, and a mouth, connections of a plurality of units constituting the body, and the like.

For example, a part point 73a is located at the connection between a finger portion and an arm portion in a right front leg portion unit 154. A part point 73b is located at the connection between the right front leg portion unit 154 and a body portion unit 153. A part point 73c is located at the connection between a head portion unit 152 and the body portion unit 153. A part point 73d is located at the connection between a left front leg portion unit and the body portion unit 153.

Next, when the pet-type robot 21 takes a specific posture, the part point is used to determine whether the robot 28 of the same type takes the same posture as that of the pet-type robot 21 in a mirror-symmetrical positional relationship to perform self-detection.

For example, assumption is made that the pet-type robot 21 takes a position of raising the left front leg from a posture of lowering the left front leg. The position coordinate of the part point 73a of the robot 28 of the same type changes, the robot 28 of the same type is assumed to take the same posture as that of the pet-type robot 21 in a mirror-symmetric positional relationship when this change is the same as the positional change of the connection between the finger portion and the arm portion in the left front leg unit of the pet-type robot 21, and the robot 28 of the same type is determined to be a mirror image of the pet-type robot 21 (itself) displayed in the mirror 65.

Note that although taking a specific posture has been described as an example here, time-series gesture recognition may be used.

### Other Embodiments

The embodiment of the present technology is not limited to the embodiments described above, and various modifications can be made without departing from the essence of the present technology.

For example, the trigger monitoring unit 5 may monitor occurrence or non-occurrence of a trigger using image information of the shadow of a pet-type robot. For example, by comparing the contour shape of the shadow serving as image information of the shadow of a pet-type robot when no accessory acquired at a certain time point is attached with the contour shape of the shadow serving as image information of the shadow of a pet-type robot acquired at the current time point, occurrence or non-occurrence of an accessory may be estimated. It is determined that a trigger has occurred when it is presumed that an accessory may be attached, and the processing relating to state change detection is started.

Further, an example in which an image, segmentation, part detection, a feature amount, and the like are used at the time of state-change-detection processing, and cases where the robot information databases is used and is not used have been described in the above-mentioned embodiments, these may be combined for performing the state-change-detection processing.

Further, an example in which state change detection is performed using image information has been described in the above-mentioned embodiments. State-change-detection processing may be performed using voice information such as environmental sound, actuator operation sound, and sound generated by the pet-type robot itself in addition to such image information.

For example, when there is a change in the environmental sound, which is voice information collected by the microphone, it is assumed that there is a possibility that an accessory is attached in a region where the microphone is located. Therefore, the reference voice acquired by the voice acquisition unit at a certain point is compared with the comparison voice acquired by the voice acquisition unit at another time point, and a state change of the pet-type robot can be detected on the basis of the comparison result.

Further, when there is a change in the operation sound of an actuator, it is assumed that there is a possibility that an accessory is attached in the region where the actuator is located. Therefore, a reference operation sound of an actuator serving as the reference voice acquired by the voice acquisition unit at a certain time point is compared with a comparison operation sound of the actuator serving as the comparison voice acquired by the voice acquisition unit at another time point, and a state change of the pet-type robot can be detected on the basis of the comparison result.

Further, when there is a change in the sound generated by the pet-type robot itself, it is assumed that there is a possibility that an accessory is attached in a region of the pet-type robot where the speaker is located and the accessory blocks the speaker. Therefore, the reference voice acquired by the voice acquisition unit at a certain time point is compared with the comparison voice acquired by the voice acquisition unit at another time point, and a state change of the pet-type robot can be detected on the basis of the comparison result.

By taking into account the assumption result by such voice information, the region where the state has changed can be narrowed down, and state change detection can be performed efficiently. These pieces of voice information may also be a trigger to initiate state-change-detection processing.

Further, pattern light may be used as another example of self-detection processing in the second embodiment. By applying the pattern light to the detected robot 28 of the same type, it is possible to grasp the shape and position of the object to be irradiated with the pattern light. For example, when the object to be irradiated with pattern light is recognized to be a planar shape, it is estimated that the detected robot 28 of the same type is a mirror image of the pet-type robot 21 displayed in a mirror. Meanwhile, if the object to be irradiated with patterned light has a three-dimensional shape, it is determined that the detected robot 28 of the same type is another robot different from the pet-type robot 21.

Further, as another example of self-detection processing, when the detected robot 28 of the same type is detected as a planar shape using a depth sensor, it can also be estimated that the detected robot 28 of the same type is a mirror image of the pet-type robot 21 displayed in a mirror.

Further, as another example of self-detection processing, when the form is changed by changing the color of the eye of the pet-type robot 21, for example and the robot 28 of the same type changes the form to change the color of the eye similarly, it can be determined that the detected robot 28 of the same type is a mirror image of the pet-type robot 21 displayed in a mirror.

Further, when the pet-type robot 21 moves in state-change-detection processing as shown in FIG. 22, a region other than the robot region that moves in the same manner as the robot region may be extracted as a state change region (region of the hat 62).

FIG. 22 is a diagram showing a state before and after the pet-type robot 21 wearing the hat 62 moves leftward, and shows the state where an area other than the robot region that moves in the same manner as the robot region, here, the region of the hat 62, is detected. Before and after the moving, the region moving in the image is a region surrounded by a rectangle 71.

Further, the four-legged walking pet-type robot is exemplified as an autonomously acting robot in the above-mentioned embodiments, but the present technology is not limited thereto. Any autonomously acting robot may be used as long as it includes a bipedal, or a bipedal or more multipedal walking, or another moving means, and communicates with a user autonomously.

It should be noted that the present technology may take the following configurations.

(1) An information processing apparatus, including:

a state-change detection unit that compares reference image information regarding an autonomously acting robot acquired at a certain time point with comparison image information regarding the autonomously acting robot acquired at another time point, and detects a state change of the autonomously acting robot on a basis of a comparison result.

(2) The information processing apparatus according to (1) above, in which

the state change is presence or absence of an accessory attached to the autonomously acting robot.

(3) The information processing apparatus according to (1) or (2) above, further including
an action-control-signal generation unit that generates, for state-change-detection processing by the state-change detection unit, an action control signal of the autonomously acting robot so that a posture of the autonomously acting robot is the same as that in the reference image.
   (4) The information processing apparatus according to any one of (1) to (3) above, in which
the comparison image information is image information of the autonomously acting robot moved in accordance with the reference image information.
   (5) The information processing apparatus according to any one of (1) to (4) above, in which
the state-change detection unit detects the state change from a difference between the comparison image information and the reference image information.
   (6) The information processing apparatus according to any one of (1) to (5) above, in which

the reference image information includes a feature amount of a reference image,

the comparison image information includes a feature amount of a comparison image, and

the state-change detection unit compares the feature amount of the comparison image with the feature amount of the reference image to detect the state change.

(7) The information processing apparatus according to any one of (1) to (6) above, in which

the reference image information includes segmentation information of pixels that belong to the autonomously acting robot, and

the state-change detection unit detects the state change by using the segmentation information to remove a region that belongs to the autonomously acting robot from the comparison image information.

(8) The information processing apparatus according to (7) above, in which

the autonomously acting robot includes a plurality of parts, and

the segmentation information includes pixel segmentation information for each of the plurality of parts distinguishable from each other.

(9) The information processing apparatus according to any one of (1) to (8) above, further including

a self-detection unit that detects whether or not a robot detected to be of the same type as the autonomously acting robot is the autonomously acting robot.

(10) The information processing apparatus according to (9) above, in which

the self-detection unit detects, on a basis of movement performed by the autonomously acting robot and movement performed by the robot detected to be of the same type, whether or not the robot detected to be of the same type is the autonomously acting robot displayed on a member that displays an object using specular reflection of light.

(11) The information processing apparatus according to (9) above, in which

the self-detection unit estimates a part point of the robot detected to be of the same type, and detects, on a basis of a positional change of the part point and movement of the autonomously acting robot, whether or not the robot detected to be of the same type is the autonomously acting robot displayed on a member that displays an object using specular reflection of light.

(12) The information processing apparatus according to any one of (1) to (11) above, in which

the autonomously acting robot includes a voice acquisition unit that collects a voice, and

the state-change detection unit compares a reference voice acquired by the voice acquisition unit at a certain time point with a comparison voice acquired by the voice acquisition unit at another time point and detects the state change of the autonomously acting robot on a basis of a comparison result.

(13) The information processing apparatus according to any one of (1) to (12) above, in which

the autonomously acting robot includes an actuator that controls movement of the autonomously acting robot, and

the state-change detection unit compares a reference operation sound of the actuator at a certain time point with a comparison operation sound of the actuator acquired at another time point and detects the state change of the autonomously acting robot on a basis of a comparison result.

(14) The information processing apparatus according to any one of (1) to (13) above, further including

a trigger monitoring unit that monitors occurrence or non-occurrence of a trigger for determining whether or not the autonomously acting robot is to be detected by the state-change detection unit.

(15) The information processing apparatus according to (14) above, in which

the trigger monitoring unit compares image information regarding a shadow of the autonomously acting robot at a certain time point with image information regarding a shadow of the autonomously acting robot at another time point to monitor the occurrence or non-occurrence of the trigger.

(16) The information processing apparatus according to (14) or (15) above, in which

the trigger monitoring unit monitors the occurrence or non-occurrence of the trigger on a basis of an utterance of a user.

(17) The information processing apparatus according to any one of (14) to (16) above, in which

the trigger monitoring unit monitors the occurrence or non-occurrence of the trigger on a basis of a predetermined elapsed time.

(18) An information processing system, including:

an autonomously acting robot; and

an information processing apparatus including a state-change detection unit that compares reference image information regarding the autonomously acting robot acquired at a certain time point with comparison image information regarding the autonomously acting robot acquired at another time point, and detects a state change of the autonomously acting robot on a basis of a comparison result.

(19) A program that causes an information processing apparatus to execute processing including the step of:

comparing reference image information regarding an autonomously acting robot acquired at a certain time point with comparison image information regarding the autonomously acting robot acquired at another time point, and detecting a state change of the autonomously acting robot on a basis of a comparison result.

(20) An information processing method, including:

comparing reference image information regarding an autonomously acting robot acquired at a certain time point with comparison image information regarding the autonomously acting robot acquired at another time point, and detecting a state change of the autonomously acting robot on a basis of a comparison result.

### REFERENCE SIGNS LIST

1, 21 pet-type robot (autonomously acting robot, information processing apparatus)
2 trigger monitoring unit
6 state-change detection unit
7 action-control-signal generation unit
17 actuator
53 body portion (part)
61, 63, 64 bracelet (accessory)
62 hat (accessory)
65 mirror (member that displays an object using specular reflection of light)
73a to 73d part point
80 mask image for reference (reference image information)
81 RGB image for reference (reference image information)
82 comparison image (comparison image information)
87 reference image that reflects pixel segmentation information for each part (reference image information)
100, 200, 300 information processing system
110 pet-type robot, first pet-type robot (autonomously acting robot)
120 server (information processing apparatus)
220 second pet-type robot (information processing apparatus)
521 face portion (part)
522 right ear portion (part)
523 left ear portion (part)

1. An information processing apparatus, comprising:
a state-change detection unit that compares reference image information regarding an autonomously acting robot acquired at a certain time point with comparison image information regarding the autonomously acting robot acquired at another time point, and detects a state change of the autonomously acting robot on a basis of a comparison result.

2. The information processing apparatus according to claim 1, wherein
the state change is presence or absence of an accessory attached to the autonomously acting robot.

3. The information processing apparatus according to claim 2, further comprising
an action-control-signal generation unit that generates, for state-change-detection processing by the state-change detection unit, an action control signal of the autonomously acting robot so that a posture of the autonomously acting robot is the same as that in the reference image.

4. The information processing apparatus according to claim 3, wherein
the comparison image information is image information of the autonomously acting robot moved in accordance with the reference image information.

5. The information processing apparatus according to claim 4, wherein
the state-change detection unit detects the state change from a difference between the comparison image information and the reference image information.

6. The information processing apparatus according to claim 5, wherein
the reference image information includes a feature amount of a reference image,
the comparison image information includes a feature amount of a comparison image, and
the state-change detection unit compares the feature amount of the comparison image with the feature amount of the reference image to detect the state change.

7. The information processing apparatus according to claim 5, wherein
the reference image information includes segmentation information of pixels that belong to the autonomously acting robot, and
the state-change detection unit detects the state change by using the segmentation information to remove a region that belongs to the autonomously acting robot from the comparison image information.

8. The information processing apparatus according to claim 7, wherein
the autonomously acting robot includes a plurality of parts, and
the segmentation information includes pixel segmentation information for each of the plurality of parts distinguishable from each other.

9. The information processing apparatus according to claim 5, further comprising
a self-detection unit that detects whether or not a robot detected to be of the same type as the autonomously acting robot is the autonomously acting robot.

10. The information processing apparatus according to claim 9, wherein
the self-detection unit detects, on a basis of movement performed by the autonomously acting robot and movement performed by the robot detected to be of the same type, whether or not the robot detected to be of the same type is the autonomously acting robot displayed on a member that displays an object using specular reflection of light.

11. The information processing apparatus according to claim 9, wherein
the self-detection unit estimates a part point of the robot detected to be of the same type, and detects, on a basis of a positional change of the part point and movement of the autonomously acting robot, whether or not the robot detected to be of the same type is the autonomously acting robot displayed on a member that displays an object using specular reflection of light.

12. The information processing apparatus according to claim 9, wherein
the autonomously acting robot includes a voice acquisition unit that collects a voice, and
the state-change detection unit compares a reference voice acquired by the voice acquisition unit at a certain time point with a comparison voice acquired by the voice acquisition unit at another time point and detects the state change of the autonomously acting robot on a basis of a comparison result.

13. The information processing apparatus according to claim 12, wherein
the autonomously acting robot includes an actuator that controls movement of the autonomously acting robot, and
the state-change detection unit compares a reference operation sound of the actuator at a certain time point with a comparison operation sound of the actuator acquired at another time point and detects the state change of the autonomously acting robot on a basis of a comparison result.

14. The information processing apparatus according to claim 12, further comprising
a trigger monitoring unit that monitors occurrence or non-occurrence of a trigger for determining whether or not the autonomously acting robot is to be detected by the state-change detection unit.

15. The information processing apparatus according to claim 14, wherein
the trigger monitoring unit compares image information regarding a shadow of the autonomously acting robot at a certain time point with image information regarding a shadow of the autonomously acting robot at another time point to monitor the occurrence or non-occurrence of the trigger.

16. The information processing apparatus according to claim 14, wherein
the trigger monitoring unit monitors the occurrence or non-occurrence of the trigger on a basis of an utterance of a user.

17. The information processing apparatus according to claim 14, wherein
the trigger monitoring unit monitors the occurrence or non-occurrence of the trigger on a basis of a predetermined elapsed time.

18. An information processing system, comprising:
an autonomously acting robot; and
an information processing apparatus including a state-change detection unit that compares reference image information regarding the autonomously acting robot acquired at a certain time point with comparison image information regarding the autonomously acting robot acquired at another time point, and detects a state change of the autonomously acting robot on a basis of a comparison result.

19. A program that causes an information processing apparatus to execute processing including the step of:
comparing reference image information regarding an autonomously acting robot acquired at a certain time point with comparison image information regarding the autonomously acting robot acquired at another time point, and detecting a state change of the autonomously acting robot on a basis of a comparison result.

20. An information processing method, comprising:
comparing reference image information regarding an autonomously acting robot acquired at a certain time point with comparison image information regarding the autonomously acting robot acquired at another time point, and detecting a state change of the autonomously acting robot on a basis of a comparison result.
